(19) United States
(12) Patent Application Publication
(10) Pub. No.: US 2009/0008336 A1
(43) Pub. Date: Jan. 8, 2009

(54) Improvements to a Fluid Jet Flotation Apparatus

(76) Inventor: Gregory John Harbort, Queensland (AU)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/791,735

(22) PCT Filed: Nov. 25, 2005
(86) PCT No.: PCT/AU2005/001786

§ 371 Date: Apr. 14, 2008

(30) Foreign Application Priority Data
Nov. 26, 2004 (AU) 2004906752

(51) Int. Cl. B03B 1/06; B03D 1/00; B03D 101/04; B03D 1/26; B03D 1/14

(52) U.S. Cl. 210/703; 210/221.2; 210/137; 210/197

(57) ABSTRACT

A fluid jet flotation apparatus 1 is disclosed. The apparatus 1 comprises a tank 10 containing a liquid having a relatively lower region and a relatively upper region and a conduit 2 having a liquid inlet 5 through which a particle-containing liquid is introduced to the conduit 2 as a jet. The conduit 2 also includes a gas inlet 6 through which gas is drawn into the conduit 2 by the jet, the liquid and the gas forming a foam bed that is displaced through the conduit 2 and out through an outlet 24 remote from the inlet 5. The outlet 24 is positioned to discharge the foam bed from the conduit 2 into the tank 10 in an upward direction and in a relatively upper region of the tank. This enhances the separation of value particles in the froth from waste particles in the body of liquid. Further, the reduced pressure at the outlet 24 of the conduit 2 enhances the draw and thereby the volumetric throughput through the conduit 2. In the drawing the conduit comprises a downcomer and then a riser extending up from the downcomer. The apparatus also includes a froth recovery means for recovering particle laden froth from a froth layer that forms above the liquid in the tank 10. The tank 10 has a peripheral wall 11 with an upper edge defining a top that opens to the atmosphere and the froth recovery means comprises an overflow weir 15 formed by said upper edge of the tank 10 over which the froth layer can be discharged from the tank 10.

### FIELD OF THE INVENTION

This invention relates broadly to a fluid jet flotation apparatus. The invention extends to a method of using the jet fluid flotation apparatus for carrying out flotation.

This invention relates particularly but not exclusively to a fluid jet flotation apparatus that is based on a Hebbard flotation machine used for the beneficiation of mineral ores such as coal and it will be convenient to hereinafter describe the invention with reference to this example application. However, it is to be clearly understood that the invention is capable of broader application. For example the flotation apparatus could be used for the concentration of any one of a number of minerals, including copper, gold and nickel. It could also be used for the removal of oil droplets or emulsified oil particles from an aqueous liquid, as well as the removal of fibrous or vegetable matter such as paper fibres and bacterial cells from liquids.

The Jameson Cell which is a sub set of the group of Hebbard flotation machines is the most common type of Hebbard flotation machine in operation in mineral beneficiation plants around the world.

### BACKGROUND TO THE INVENTION

Flotation is a process for the separation of value particulate materials from a mix of value particles and waste particles suspended in a liquid that is usually water. The mixture of solids and water is sometimes referred to as a pulp or slurry.

The value particle is desired to be recovered and the waste particles contain at least one other type of particle different from the value particle that is not desired to be recovered and will ultimately be disposed of as waste.

The particles are treated with a chemical known as a collector. This makes the surface of the value particles water repellant or hydrophobic. The treatment with the collector does not alter the surface properties of the other particles and they remain hydrophilic or water attracting which is the opposite of hydrophobic. This confers the necessary surface property on the value particles that the other particles do not have to enable the separation of the two to take place in the flotation process.

To physically effect the separation of the hydrophobic particles with value from the waste hydrophilic particles air is pumped into a body of water containing the particles in suspension where it forms bubbles. The bubbles provide a surface area exposed to both gas and liquid phases.

The hydrophobic value particles have the property that they adhere to the surface of the bubbles when they come into contact with it. As the bubbles then rise through the liquid the value particles move up with the bubbles and provided they continue to stick to the bubbles they move with the bubble into a froth layer on the top of the liquid. Frothing agents may assist in the formation of a stable froth on the surface of the liquid.

The value particles are then floated off the water in the froth layer, e.g. by means of overflow and are effectively separated from the waste particles at this point. The hydrophilic particles are left behind in the body of the liquid and are drained away together with the body of water.

In conventional flotation cells, the particle containing water is brought into contact with the air bubbles in a simple tank, e.g. a rectangular tank. An air stream can be pumped into the tank. This air stream can be broken up and bubbles can be generated by a paddle or stirrer mounted for rotation within the tank. Essentially, this is the simplest form of flotation cell. However, it will readily be appreciated that there are real limits on the extent of gas liquid surface area that can be created per unit time with this basic cell. There is therefore a need to increase the amount of value particles that could be attached at any one tine by increasing the surface area between the gas and liquid phases. There is also a need to increase the volume of gas and liquid at any one time to increase the capacity of the process.

An advance on the basic flotation cell described above is known as a column flotation cell.

In column flotation a liquid with suspended particles is introduced into a vertical column towards its top and flows down the column under the influence of gravity. Pressurised air is introduced into the bottom of the column under pressure and this rises up through the column counter current to the descending water and particles. A layer of froth similar to that described above (hereinafter referred to as the froth layer) forms above the water and flows over the top of the column. The water containing the waste particles is discharged from the bottom of the column. The position of the froth-liquid interface is maintained at a desired level by controlling the amount of water that is allowed to flow out of the bottom of the column. This is regulated by means of a valve, e.g. a control valve.

Optionally in column flotation wash water may be fed from above into the froth layer. This water flows through the froth and entrains waste particles that have incorrectly reported to the froth. This can thus improve the efficiency of column flotation.

In these columns the liquid flows down while the bubbles rise up due to buoyancy. Since the rise velocity of the bubbles is related strongly to their size, the bubbles must have a size and a diameter above a certain critical diameter for them to be able to rise up through the liquid and into the froth layer. This can be difficult to accomplish while still maintaining a satisfactory through put through the column. Operators of flotation columns have encountered problems in getting them to operate effectively and this has limited their uptake in mineral processing plants.

Another development in the evolution of these machines was the development of a fluid jet flotation machine by Seale and Shelishear. In this machine the fluid that is a liquid is directed down through the column as a jet. Subsequent there to a person by the name of Hebbard devised an improvement to this basic machine.

A development of the fluid jet flotation machine was the development of Jameson Cell by an Australian, Graeme Jameson in the 1980's. A schematic illustration of Jameson Cell is provided in FIG. 1.

The Jameson Cell comprises a vertically extending column (downcomer) that has a liquid inlet at its upper end through which liquid is pumped under pressure as a jet down into the column. The column also includes an air inlet adjacent the liquid inlet and the reduced pressure caused by the jet of liquid causes air to be entrained in the liquid. This causes a foam to build up in the column (hereinafter referred to as a foam bed or foam column) and for the foam column to travel down the physical column and out through the lower end thereof. The foam travels down the column in a manner that approximates plug flow and the superficial velocity of the foam bed can be determined.

The column has an outlet at its lower end that is submerged within a tank containing a liquid that is usually water. When the foam bed issues from the lower end of the column it forms froth bubbles that rise up through the body of liquid in the tank to form a froth layer on top of the body of liquid. The froth layer is quite distinct and there is a clear line of separation between the froth and the liquid.

The waste particles are separated from the attached value particles in the body of liquid after they are discharged from the downcomer. The value particles that are attached to interfacial surface area rise up through the liquid. By contrast the particles that have not attached to any part of the interfacial surface area are effectively freely suspended within the body of liquid and start to settle under the influence of gravity. They start displacing down through the body of the liquid towards a bottom region of the tank. The value articles attached to the surface of the foam displace upwardly towards the froth layer. Once they reach the top of the liquid provided they are sufficiently strongly attached to the foam they move into the froth layer.

The froth layer is then progressively removed from the liquid via an overflow weir formed by the upper edge of the tank. The waste particles settle in a lower region of the tank where they are held or retained for a period of time usually before being removed by draining liquid from the tank through an outlet line at the bottom of the tank.

The fluid jet flotation cell has some benefits over other flotation apparatuses.

The foam column or foam bed provides a high inter phase surface area between gas and liquid phases. This makes it easier for the hydrophobic particles in the body of the liquid to attach to the lining of the gas phase in the time that they are in the column. Further, the vigorous mixing within the column increases the movement of the value particles and makes it more likely that they will come into contact with the interfacial surface area. For a value particle to be recovered in the froth overflow it first of all needs to be attached to the foam.

Another advantage is that the pressure in the column is a negative pressure that is below atmospheric pressure. This is due to the jet of liquid that is directed into the column through a nozzle. This negative pressure causes air to be drawn or sucked into the column through an air inlet that is just down stream from the nozzle that produces the jet. The air does not need to be pumped into the column.

Jameson Cells have been widely installed in processing plants carrying out flotation. In particular, the Jameson Cells have found application in coal flotation plants. Despite their advantages Jameson Cells still have limitations.

For example, it would be advantageous if the recovery of value particles in a Jameson Cell could be improved. With current machines some of the value particles are being discharged from the body of the liquid with the tailings and are not reporting to the froth. Even under optimal flow rates and other operating conditions the amount of value product being lost with the tailings is quite significant. This loss of product represents a huge monetary amount for mine operators particularly where valuable minerals such as gold and copper are concerned. Clearly therefore, it would be advantageous if even a small amount of this value product which is currently being lost could be recovered in the froth flowing over the overflow weir.

Further, the volumetric flow rate of air and water that can be pushed through the column of current fluid jet flotation apparatuses is limited. The foam bed issuing from the outlet of the column has to issue into the body of the liquid in the tank and to do this it has to displace water in the tank. While this can be accomplished easily enough at low flow rates it becomes harder and harder to do when volumetric flow rates through the column are increased. If an operator endeavours to increase the volumetric flow rate of water and air through the column then the performance of the apparatus starts to deteriorate. A steadily increasing percentage of the value particles is discharged from the tank in the body of liquid and is lost. Further, a greater amount of energy which is represented by the electrical current drawn by the motor for the pump is required to displace a unit volume of water and air through the column and into the body of liquid in the tank. Applicant believes that considerable efforts have been directed to addressing this problem but little progress has been made.

Workers in the field have surmised that the reason for this reduced performance at increased flow rates is due to a drop off in performance in the column or downcomer as distinct from the tank of water or pulp. That is the formation of the foam bed in the column and its effectiveness in attaching value particles to the interfacial surface is reduced.

Clearly it would be advantageous if improvements could be made to the basic Jameson Cell to improve its performance and its versatility. Specifically, it would be advantageous if the recovery of value particles in the froth layer during normal operation could be improved. It would also be advantageous if the volumetric throughput of slurry through the column could be increased without sacrificing performance. That way a greater volume of foam bed could be pushed through the apparatus and more material could be processed. In view of the large tonnages of ore passed through these mineral beneficiation plants even a small improvement in throughput would lead to savings of millions of dollars.

### SUMMARY OF THE INVENTION

According to one aspect of this invention there is provided a fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank; and
a froth recovery means for recovering a particle laden froth from a froth layer that is formed by froth rising up through the liquid in the tank;
wherein the outlet of the conduit is spaced above a bottom of the tank.

Thus a liquid containing both value particles that are sought to be recovered and also waste particles that are to be discarded are pumped into the foam conduit. The value particles attach to the surface of the foam and can rise up through the liquid due to the buoyancy of the bubbles to the froth layer from where they are floated off. The waste particles gradually fall through the liquid in the tank to the bottom from where they are discharged from the tank with water.

By having the outlet of the conduit spaced above the bottom of the tank, the froth issuing from the conduit is moved away from the region when waste particles collect before they are discharged from the tank. It also positions the outlet closer to the froth layer above the liquid in the tank. It also reduces the static pressure in the liquid at the outlet of the conduit when compared with that at the bottom of the tank.

Conveniently the liquid may be water and the gas may be air. The foam bed may have a superficial velocity in the conduit of 0.05-0.09 m/s.

The outlet of the conduit may be positioned in the relatively upper region of the tank such that foam issuing from the outlet passes into the liquid in said relatively upper region of the tank.

The conduit outlet may be positioned at least a quarter of the way up the height of the tank, the height being measured from a bottom of the tank to an upper edge of the tank. In one form the conduit outlet may be positioned at least half way up the height of the tank.

The outlet of the conduit in addition may face upwardly.

In one form of the invention, the conduit may comprise a first downwardly extending section that is a primary column that extends down from the inlet and then changes direction and a second section that is a secondary column extending up to the outlet, e.g. discharging the foam bed into the tank at a position spaced above the bottom of the tank.

In another form of the invention, the conduit may extend from an inlet above the tank, e.g. in a substantially linear fashion, down to an outlet that is positioned spaced above a bottom of the conduit.

Specifically, the outlet may be positioned in a relatively upper region of the conduit.

In another form of the invention, the conduit may extend in a lateral or sideways direction from the inlet outside the tank, e.g. in a substantially linear fashion, to an outlet within the tank that is positioned spaced above a bottom of the tank.

The first downwardly extending primary column may extend substantially vertically down from the inlet and the secondary column extend substantially vertically upwardly up to the outlet in a direction broadly opposed to the direction of the downwardly extending primary column.

The primary column may have a lower end that is open and the secondary column may longitudinally straddle the lower end of the primary column and have a lower end that is proximate to the lower end of the primary column and an upper end that opens into the tank above the lower end of the primary column.

In longitudinally straddling the lower end of the primary column the lower end of the secondary column is positioned below the lower end of the primary column and extends up therefrom so that it circumferentially surrounds the lower end of the primary column. The upper end of the secondary column may be spaced a good distance above the lower end of the primary column.

The height of the secondary column may be at least one quarter of the distance from the lower end of the primary column to the level of the weir on the tank, preferably at least two fifths of the distance from the lower end of the primary column up to the weir of the tank.

The outlet of the secondary column may be spaced beneath the weir and/or the froth layer, e.g. by at least 200 mm. In one form the outlet is spaced 250-350 mm below the weir or the froth layer. Thus, the foam bed issuing from the outlet clearly enters the body of liquid as distinct from the froth layer.

Thus, liquid slurry containing particles to be treated is passed through the inlet under pressure and this draws air into the primary column. This generates a foam bed or stream that moves down the primary column and out through the lower end thereof. The foam bed is then drawn into the secondary column and travels up this column and out through the upper end thereof and into the liquid in the tank. The foam bed forms bubbles that rise through the liquid and into the froth layer from where the froth is removed via the overflow weir. Liquid within the tank is drawn off through the outlet in the bottom of the tank.

The secondary column may circumferentially surround the primary column along the full length of the secondary column from its lower end to its upper end defining an annular space outside of the primary reactor.

Alternatively the secondary column, towards its lower end, may circumferentially surround the lower end of the primary column and then the secondary column may be directed or angled away from the primary column such that the upper end thereof does not surround the column.

The conduit may include means for adjusting the pressure inside the conduit by admitting liquid from the tank into the conduit intermediate the inlet and the outlet of the conduit, e.g. positioned between the downwardly extending primary column and the upwardly extending secondary column.

The lower end of the secondary column may be open and the means for adjusting the pressure in the conduit may comprise a damper that is mounted over the open lower end of the secondary column. The damper may be adjustable to adjust the flow of liquid from the tank into the secondary column whereby to adjust the rate of flow of the foam in the secondary column.

The damper may comprise an end cap with an end plate and a side wall that extends up from the end plate around the circumference thereof. The end cap may be complementary to the lower end of the secondary column but slightly larger than the secondary column and a side wall that extends up from the end plate around the circumference thereof and fits around the wall of the secondary column, e.g. with a small spacing. The end cap may be movable in a direction towards and away from the lower end of the secondary column section in a longitudinal direction.

The damper may further define a solids outlet and associated closure for enabling an operator to discharge accumulated solids on the damper from the conduit. This will involve removing the closure to open the outlet draining the solids then putting the closure back on straight afterwards. This enables a build-up of coarse solids in the secondary column to be resisted. The solids outlet and closure are controlled so that they substantially resist and control the recirculation of liquid from the main tank into the secondary column.

The tank may have an open top and define an upper edge that is positioned above the outlet of the primary column. The froth recovery means may be located on said tank. Specifically, the froth recovery means may comprise an overflow weir formed by said upper edge of the tank over which froth from the froth layer can be discharged from the tank.

The tank may also include a liquid outlet, e.g. in the bottom of the tank, through which liquid can be removed from the tank. The tank may also include valve means, e.g. in the form of a control valve for controlling the flow of liquid out of the tank through the liquid outlet. The liquid outlet assists in the removal of liquid and waste particles from the tank after they have settled out after being discharged from the conduit.

The apparatus may further pumping means for pumping a liquid through the liquid inlet, e.g. in the form of a centrifugal pump driven by a pump motor that is an electric motor.

The inlet to the conduit may be formed by a nozzle that then forms a jet of liquid that enters the primary column.

The apparatus may further include a supply of gas that can be drawn into the column through the gas inlet. The negative pressure generated in the column due to the jet may draw the gas into the column so that it does not need to be pumped into the conduit. The gas may be air.

The primary column may have a circular cylindrical configuration. However this is not essential and other configurations could also be used. Conveniently the tank may also have a circular cylindrical configuration. However, other shapes such as rectangular could also be used.

The apparatus may further include a recycle conduit extending from an inlet positioned within the body of liquid within the tank to a recycle conduit outlet that is positioned in the conduit containing the foam bed that has high levels of aeration. The outlet may be positioned within the primary column or secondary column and particularly the primary column.

In this way liquid and unattached value particles within the body of liquid inside the tank can be returned to a region of high aeration within the primary column. In the primary column value particles are given a further opportunity to be attached or re-attached to a surface of the foam and then be carried up in the liquid into the froth layer.

The hydrostatic pressure in the primary column is lower than atmospheric pressure due to the jet of liquid and the body of liquid within the tank is at a pressure that is higher than atmospheric. Thus, water and associated particles will be displaced from the tank into the primary column by utilising this pressure gradient. The water thus does not need to be pumped from the tank into the conduit.

One such recycle conduit may extend from an upper region of the body of liquid in the tank to a point on the primary column above the tank and below the gas inlet. This returns fine material in the body of the liquid to the primary column where it is mixed in again with the froth column and can be attached to the froth in the column.

A further recycle conduit may extend from a point near the bottom of the tank up to a point on the secondary column spaced above it. The further recycle conduit may recycle heavy or coarse particles in the bottom of the liquid into the secondary column where they are exposed to the froth column and get a further opportunity to attach to the surface of the foam and then be floated up into the froth layer. Again the liquid and coarse particles are drawn from the tank into the secondary column by the pressure gradient and do not need to be pumped into it.

The apparatus may further include means for selectively adding flotation conditioners to the liquid and these means may be located in one or more of said recycle conduits, e.g. the further recycle conduit carrying coarse particles. Coarse particles may require a greater concentration of conditioner for them to be efficaciously floated off. This is simply a function of their larger size and greater weight.

The apparatus may further include a froth conduit, e.g. a froth chimney, having an inlet positioned in proximity to the outlet of the conduit and an outlet spaced away from the outlet of the conduit. The froth conduit may extend generally away, e.g. radially and vertically, from the outlet of the conduit and the outlet may be remote therefrom.

The froth conduit may be positioned above the outlet of the conduit which is preferably facing in an upwards direction. The froth conduit may have an inlet that faces downwardly, e.g. above the upwardly facing outlet of the conduit, and an outlet that faces upwardly, e.g. spaced beneath the froth layer.

The inlet of the front conduit may be flared, e.g. with a bell shape, e.g. to encourage liquid and foam or froth in the body of liquid in proximity to the inlet to enter the froth chimney.

As described above the conduit having the foam bed may comprise primary and secondary columns and the inlet of the froth conduit may be positioned above and in proximity to the outlet of the secondary column.

The froth conduit may be a froth chimney for directing froth away from the primary column.

The froth chimney may enhance froth movement away from the upper end of the secondary column and reduce the back pressure or hydrostatic pressure at this point and thereby increase froth draw through the upstream conduit, i.e. the secondary column and also the primary column upstream thereof.

The apparatus may include a further damper that is a froth chimney damper associated with the froth conduit. The further damper may be mounted over the upwardly facing outlet of the froth chimney. The damper may comprise a plate that can be slid across the outlet of the froth chimney.

The further damper enables the velocity of liquid and froth flow through the froth conduit to be controlled. This influences the quality of the froth.

As described above in one form the froth recovery means is formed by a weir formed by the upper edge of the tank over which the froth layer flows.

Alternatively, the froth recovery means may take another form. For example, the froth recovery means may comprise a froth recovery vessel that is separate from the tank and spaced away from the tank, and a froth transfer conduit having an inlet in operative association with the outlet of the conduit, or the froth chimney if there is one, and the froth transfer conduit having an outlet that is in operative association with the froth recovery vessel such that froth issuing from the froth transfer conduit enters liquid within the froth recovery vessel.

The froth recovery vessel may contain liquid like said one tank and have an overflow weir over which the froth passes to remove it from the apparatus.

The froth recovery vessel may be positioned higher than the tank such that the froth has a high static head that can be used to displace the froth to the next stage of downstream processing. Thus, this may obviate the need to pump the froth to the next stage.

The froth recovery vessel may include means for removing and recycling liquid containing mineral from the recovery vessel. The removing and recycling means may comprise a secondary froth recycle conduit that extends from the froth recovery vessel to one of the primary or secondary columns. Preferably the recycle conduit returns the mineral containing liquid to the primary column.

This therefore returns valuable mineral that has become detached from the froth in the froth recovery vessel to a high aeration zone where it can be refloated in the froth and then recovered with the froth.

Thus, the various conduits including primary column and secondary column and froth conduit or froth transfer conduit as the case may be are hydraulically linked. As a result they influence each other. For example, a lower pressure in the secondary column enhances the draw of material out of the primary column into the secondary column. This in turn reduces the pressure within the primary column which results in an increased draw of air and liquid into the primary column. This enables an increase in air and/or liquid capacity to be achieved. The apparatus is arranged to carefully control and discourage recirculation between the secondary column and the tank.

According to another aspect of this invention there is provided a fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
a froth recovery means for recovering a particle laden froth from a froth layer that is formed by froth rising up through the liquid in the tank;
wherein the conduit is oriented such that the outlet of the conduit faces in an upward direction.

Thus, the outlet of the conduit faces upwardly and froth and bubbles issuing from the outlet can pass directly upward, e.g. in a vertically upward substantially linear fashion through the body of liquid and into the froth layer. The froth bubbles are not discharged in a downward direction from where they have to change direction and move upward.

In addition to having the outlet facing upward the conduit may be positioned such that the outlet of the conduit is spaced above a bottom of the tank.

The conduit which initially is directed downward may then turn through at least 160 degrees, e.g. 180 degrees, and have an open end defining the outlet whereby to provide an outlet that faces substantially upwardly.

The conduit may comprise a downwardly directed primary column and a secondary column that circumferentially surrounds the primary column and then extends up there from to an upwardly opening upper end forming the outlet of the conduit.

According to another aspect of this invention there is provided a fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
a further conduit that is a froth conduit positioned above the outlet of the conduit and in proximity there to and extending away from the outlet of the conduit to an outlet that is remote from the inlet, the froth issuing from the conduit into a body of liquid from where it rises to form a froth layer; and
a froth recovery means for recovering a particle laden froth from a froth layer that is formed by froth rising up through the liquid in the tank.

Thus, the apparatus further includes a froth conduit for conveying or transporting froth from the outlet of the conduit to a position where it can be easily recovered in the froth layer.

The outlet of the conduit containing the foam bed may face in an upward direction and the inlet to the froth conduit may be positioned above the outlet of the conduit in proximity there to.

The conduit containing the foam bed may comprise a downwardly extending primary column and an upwardly extending secondary column that is downstream of the primary column and the outlet of the secondary column may face upwardly and may be in proximity to the inlet of the froth conduit.

The froth conduit may have an inlet that faces downwardly and an outlet that faces upwardly. The inlet of the froth conduit may be flared, e.g. with a bell shape.

The froth conduit may extend radially and/or upwardly away from the outlet of the conduit. The froth conduit may be angled upwardly and outwardly away from the primary column.

The apparatus may include a further damper located proximate to the upper end of the froth chimney.

The froth conduit may resemble a chimney and may be called a froth chimney.

The froth chimney enhances froth movement away from the upper end of the secondary column and reduces the back pressure or hydrostatic pressure at this point and causing an increased froth draw.

The froth recovery means may comprise a weir formed by an upper end of the tank over which the froth flows as described above in the preceding aspects of the invention. The froth bubbles exiting the froth chimney may rise up through the liquid into the froth layer in the usual way as described above due to its lower density.

The apparatus may include a further froth recovery tank separate from said one tank and the froth conduit may extend upward and out of said one tank to said further froth recovery tank. In this particular application where the froth conduit discharges froth into a tank outside of said one tank it may be called a froth transfer conduit.

The outlet of the froth conduit may discharge into a liquid within the further froth recovery tank and said froth recovery means may comprise an overflow weir on said further froth recovery tank.

According to yet another aspect of this invention there is provided a fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
at least one recycle conduit extending from a point inside the tank to a point on the conduit such that liquid within the body of water in the tank can be recycled into the conduit where it is further brought into contact with the foam bed, the pressure within the body of liquid in the tank being greater than that in the conduit and this provides the driving force or pressure gradient for the liquid to be returned to the conduit; and
a froth recovery means for recovering a particle laden froth from a froth layer that is formed by froth rising up through the liquid in the tank.

Thus, the recycle conduit permits pulp, e.g. liquid and waste and value particles, to be recirculated into the conduit with the foam bed to give value particles further opportunity to attach to the foam surface. The pressure gradient permits this flow to occur naturally.

The conduit may comprise a primary column having a vertically extending orientation and a secondary column straddling the lower end of the primary column having a lower end beneath the lower end of the primary column and extending upwardly to an upper end spaced above the lower end of the primary column.

The recycle conduit may recycle liquid from the tank back into the primary column. The recycle conduit may also recycle liquid from the tank back into the secondary column. In one form there may be a recycle conduit recycling liquid from the tank back into the primary column and a further recycle conduit recycling liquid and particles from the tank back into the secondary column.

According to another aspect of this invention there is provided a fluid jet flotation apparatus, comprising:
a tank containing a liquid having a relatively lower region and a relatively upper region;
a conduit having a liquid inlet through which a particle-containing liquid is introduced to the conduit as a jet, an air inlet spaced from the liquid inlet through which air is drawn into the column by the jet, the liquid and the air forming a foam bed that is displaced through the conduit and out through an outlet remote from the inlet, the outlet being positioned within the tank such that the foam discharging through the outlet passes into the liquid within the tank;
a froth transfer conduit having an inlet positioned in proximity to the outlet of the conduit and extending away there from to an outlet positioned outside the tank;
a froth recovery tank containing liquid outside of said one tank, the outlet of the froth transfer conduit discharging into the liquid in the froth recovery tank and the froth recovery tank defining an overflow weir for enabling the froth to overflow and be separated from the liquid in the froth recovery tank.

Thus, the apparatus includes a froth transfer conduit for transferring froth from the body of liquid adjacent the outlet of the conduit to a position spaced away therefrom, e.g. a region spaced radially away from the conduit and above the conduit outlet. This permits the apparatus to have a said one or first tank of smaller volume. This means that it occupies less space and that it holds less water.

The outlet of the conduit may face upwardly and the inlet of the froth transfer conduit may face downwardly and be positioned above the outlet of the conduit in close proximity there to.

The froth transfer conduit may extend in an upward direction, i.e. in a linear fashion, and the froth recovery tank may be spaced above the one tank.

The froth recovery tank may include means for recycling liquid and associated particles from the recovery vessel back into said one conduit or said froth transfer conduit. The removing and recycling means may comprise a secondary froth recycle conduit that extends from the froth recovery vessel to the conduit carrying the foam bed or the froth transfer conduit. Preferably the recycle conduit returns the particle containing liquid to the froth transfer conduit.

This therefore enables valuable particles of interest, such as minerals that have become detached from the gas phase surface area in the froth recovery tank to be transferred to a high aeration zone where they can be refloated in the froth and then recovered with the froth.

According to yet another aspect of this invention there is provided a fluid jet flotation apparatus, comprising:
a primary column with a vertically extending orientation having an inlet through which particle-containing liquid is directed downwardly into the column associated with an upper end and a lower end which is open and also a gas inlet spaced in from the upper end;
means for introducing the liquid through the inlet under pressure so that the liquid is directed down the column;
a tank within which the primary column is received which contains liquid in use;
a froth recovery means for recovering particle-containing froth to be recovered in a froth layer separately from the liquid;
a secondary column longitudinally straddling the lower end of the primary column and circumferentially surrounding the lower end of the column, the secondary column having a substantially closed lower end proximate to the lower end of the primary column and then extending upwardly to an upper end spaced above the lower end of the primary column;
at least one recycle conduit extending from a point inside the tank to a point on the conduit such that liquid within the body of water in the tank can be recycled into the conduit where it is further brought into contact with the foam bed, the pressure within the body of liquid in the tank being greater than that in the conduit and this provides the driving force, or pressure gradient, for the liquid to be returned to the conduit; and
a froth conduit positioned above the upper end of the secondary column and extending generally away from the primary column for directing froth away from the primary column;
whereby liquid to be treated is introduced into the primary column through the liquid inlet and this generates a pressure gradient in the columns and conduit that draws gas through the gas inlet generating a column of froth that moves down the primary column, through the secondary column, through the froth conduit and then into the froth recovery means from where it is recovered.

The tank may have a peripheral wall with an upper edge defining a top that opens to the atmosphere and the froth recovery means may comprise an overflow weir formed by said upper edge of the tank over which the froth layer can be discharged from the tank.

The present invention also extends to a method of recovering value particles from a liquid containing value particles and also waste particles, which method comprises introducing the liquid into an apparatus according to any one of the aspects of invention described above and then recovering the value particles from the froth that is separated off the liquid.

The method may include recovering coal from high ash particles. It may also include recovering mineral particles, such as gold or copper particles, from gangue or tailings particles.

The invention also extends to a method of beneficiating a slurry containing particles to be recovered and other particles that are not desired to be recovered comprising passing the slurry through the fluid jet flotation apparatus described above according to any one of the preceding aspects of the invention and then recovering the mineral particles in the froth layer.

### BRIEF DESCRIPTION OF THE DRAWINGS

A fluid jet flotation apparatus and a method of utilising the apparatus in accordance with this invention may manifest itself in a variety of forms. It will be convenient to hereinafter provide a detailed description of several embodiments of the invention with reference to the accompanying drawings. The purpose of providing this detailed description is to instruct persons having an interest in the subject matter of the invention how to put the invention into practice. It is to be clearly understood, however, that the specific nature of this detailed description does not supersede the generality of the preceding statements. In the drawings:

FIG. 1 is a schematic front view of a prior art fluid jet flotation apparatus that is a Jameson Cell;

FIG. 2 is a schematic front view of a fluid jet flotation apparatus in accordance with one embodiment of the invention;

FIG. 3 is a schematic front view of a fluid jet flotation apparatus in accordance with a second embodiment of the invention;

FIG. 4 is a schematic front view of a fluid jet flotation apparatus in accordance with a third embodiment of the invention;

FIG. 5 is a schematic front view of a fluid jet flotation apparatus in accordance with a fourth embodiment of the invention;

FIG. 6 is a schematic front view of a fluid jet flotation apparatus in accordance with a fifth embodiment of the invention;

FIG. 7 is a graph of coal recovery as a function of tank residence time for various flotation apparatuses including those of the invention;

FIG. 8 is a graph of coal recovery as a function of downcomer flow for various flotation apparatuses including those according to the invention;

FIG. 9 is a comparative graph of electric current drawn by the pump motor as a function of the volumetric flow rate through the primary column;

FIG. 10 is a comparative graph of electric current drawn by the motor for the pump as a function of the strength of the vacuum in the primary column;

FIG. 11 is a comparative graph of electric current drawn by the motor for the pump as a function of the volumetric flow rate of air through the primary column;

FIG. 12 is a comparative graph of the percentage recovery of value particles in a coal flotation process as a function of the geometric mean size of the particle and also the percentage of concentrate of ash as a function of geometric mean size;

FIG. 13 is a comparative graph of the percentage recovery of value particles as a function of the volumetric feed rate through the primary column; and

FIG. 14 is a comparative graph of the percentage recovery of value particles as a function of the percentage waste particles in the values stream.

### DETAILED DESCRIPTION OF THE PREFERRED EMBODIMENTS

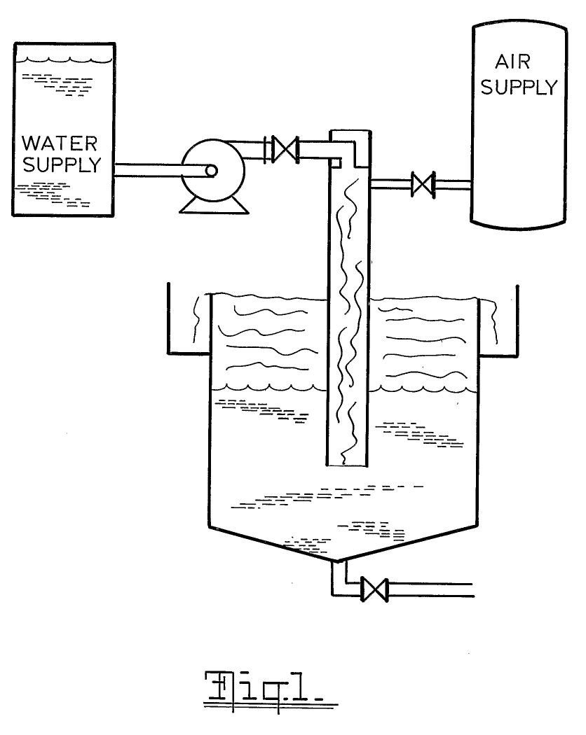

FIG. 1 illustrates a Jameson Cell which has been known for some time. This has been discussed in the background to the Invention above and will not be described in further detail in the detailed description below.

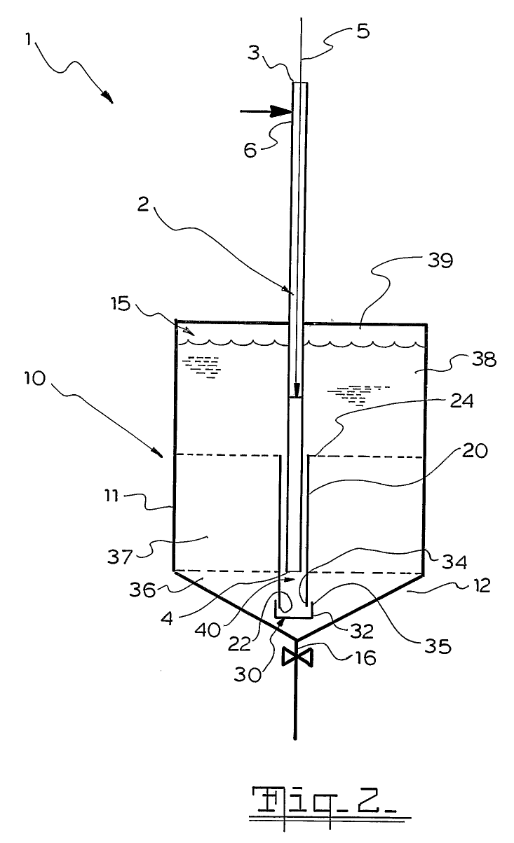

In FIG. 2 reference numeral 1 refers generally to a fluid jet flotation apparatus in accordance with the invention.

The apparatus 1 comprises broadly a tank which contains liquid and a foam conduit which extends into the tank. The foam conduit has an inlet through which particle containing liquid can be directed into the column and an outlet spaced from the inlet that is received within the column.

In FIG. 1 the foam conduit comprises a primary column 2 having an upper inlet end 3 and a lower outlet end 4. A liquid supply means in the form of a water conduit 5 enters the column 2 through the inlet which is associated with the upper end 3 and has a nozzle (not shown) at its end for directing water in the form of a jet downwardly into the column 2. The water is typically pressurised by a pump although this is not shown in the drawings.

A gas inlet 6 in the form of an air inlet is located in the side wall of the primary column 2 spaced a bit away from the upper end 3 of the column 2. The air is drawn into the column 2 by a reduced pressure is caused by the jet of liquid the column 2 and does not need to be pumped or forced into the column 2. The upper end 3 of the primary column is positioned above the tank 10.

The primary column 2 may conveniently have a circular cylindrical configuration although this need not be the case. The particular column 2 illustrated in FIG. 2 has a much greater length than diameter. Often the length may be at least twenty times the diameter of the column. However, this is not a requirement of the apparatus.

The primary column 2 has a lower region including the lower end 4 that is received in an open topped tank 10 having an open top. In the illustrated example, the tank 10 has a tank wall that has an upper cylindrical section 11 and a lower conical section 12 that tapers inwardly to a bottom 13 of the tank 10. The tank wall terminates in an upper edge the functionality of which is described in more detail below. The tank 10 has a substantially greater diameter than the primary column 2 and performs a totally different function as will become evident below.

The apparatus also includes a froth recovery means in the form of an overflow weir that enables a particle containing froth that forms above the liquid to be recovered. The weir is formed by the upper edge of the wall which forms an overflow weir 15. Further, the tank 10 includes means for removing liquid there from in the form of a drain and associated valve 16 located at the bottom of the tank. As these features of the tank 10 would be well known to persons skilled in the art they will not be described in more detail in this detailed description.

The foam conduit also includes a secondary column 20 that is effectively downstream of the primary column conduit. The secondary column 20 is in operative association with the primary column 2 and in effect forms a continuation of the flow path of the primary column 2. The secondary column 20 has a greater diameter than the primary column 2 and straddles the lower end 4 of the primary column 2 in the direction of the longitudinal axis of the column 2. Thus, the secondary column 20 circumferentially surrounds the column 2. The secondary column 20 has a lower end 22 that is positioned spaced below the lower end 4 of the primary column 2 and an upper end 24 that is spaced about half way up the height from the base of the tank 10 to the upper edge 15 of the tank 10. At the same time, the upper end 24 of the secondary column 20 is also spaced well below the level of the weir 15 and the froth on the surface of the liquid in the tank in use. Both the upper and lower ends 24 and 22 of the secondary reactor 20 are open.

Conveniently the secondary column 20 may have a complementary shape to the primary column 2 at least towards the lower end 4 thereof. The illustrated column 20 has a circular cross section and this shape has been found to be very convenient.

The apparatus 1 further includes a damper 30 mounted over the lower end 22 of the secondary column 20. The damper 30 includes a base plate 32 that has a circular configuration matching that of the secondary column 20 but is slightly larger than the column 20 and a side wall 34 that extends up from the base plate 32 around the circumference thereof. The damper 30 can be moved by an operator in a longitudinal direction towards and away from the lower end 22 of the secondary column 20 thereby to vary the extent of communication with an adjacent liquid zone or portion 35 of the tank 10. Specifically, it can be used to regulate the amount of water from the tank that is drawn into the secondary column and thereby control the draw of foam up the secondary column 20. Effectively it controls the speed at which the foam body moves up the column 20.

In use a particulate mineral containing both value particles to be recovered as valuable product and gangue, or waste particles to be discarded are placed in suspension in a liquid, which is water. This may be referred to as suspended slurry, or a pulp.

The water is conditioned with chemicals to facilitate flotation in the usual way and then the slurry is ready to be put through the apparatus 1. Specifically collectors are added to provide the surface of the value particles with a hydrophobic character. Conditioners are added to encourage the formation of a froth on top of the liquid.

Water containing particles is pumped into the primary conduit through the nozzle as a jet. The low pressure caused by the jet draws or sucks air into the column through the air inlet 6. This generates a column of foam (not shown) that then moves down the column with a flow pattern at least resembling plug flow. The foam comprises primarily a gaseous phase which is lined with a liquid. It has a large gas-liquid surface area to allow for attachment or collection of mineral particles. The foam is quite different from say bubbles that rise up a column.

Once steady state operation of the column has been established then a foam bed moves steadily down the primary column and out the bottom thereof and then into the secondary column. From there the foam bed moves up the secondary column and out the upper end thereof and into the body of liquid. The pressure in the primary and secondary columns is less than that in the body of liquid in the tank.

The foam column discharges from the lower end 4 of the primary column 2 into a space 40 defined by a bottom region of the secondary column 20. From there the column of foam moves up through the secondary column 20 and then out of the upper end 24 of the secondary column 24 and into the body of water.

The damper 30 effectively closes off the bottom of the secondary column 20 and also the primary column 2 from the liquid in the tank 10. Specifically, it does not equalise pressure inside and outside the columns. Rather, it provides a means to adjust the level of draw or pull of the foam bed through the secondary column and thereby through the rest of the apparatus. The damper 30 can be moved downwards in a direction away from the secondary column to allow some water from the body to enter the column and reduce the draw generated in the secondary column 20 and thereby the velocity of the foam in the columns 2 and 20.

The body of liquid which is water comprises a lower region 36 below the outlet 4, a central region 37 above the outlet 4 and below the outlet 24 and an upper region 38 above the outlet 24. The tank also includes a layer of froth 39 above the region 38 of the body of liquid 36. The column of foam discharges into the upper zone 38 of the body of water. The upper region 38 shows reasonably low levels of turbulence where the foam bed discharges into the body of the liquid. This is marked contrast to the turbulence experienced in the liquid when the foam bed is discharged from the downcomer in the prior art FIG. 1 apparatus.

In the upper region 38 the foam with gas phase lining and attached value particles rises up through the zone and moves into the froth layer above it. There it is effectively separated from the liquid. Provided that it does not settle back into the body of water it can be taken off with the froth layer via the overflow weir.

In the upper region 38 the waste or gangue particles fall down through the body of water due to gravity. This causes them to separate out from the foam attaching value particles. The central region thus contains waste particles that have been separated from the values and are displacing away from the upper zone. Over time these waste particles move into the lower region 36 which is effectively a holding zone or storage where the particles are held before they are discharged through the liquid outlet with other liquid from the body. The central and lower regions have a lower static pressure than the upper region.

Applicant has been able to obtain a substantially greater throughput of foam through the conduit, i.e. primary and secondary columns of the apparatus of FIG. 2 than if a cell is used that has only a downcomer. The increase in volumetric throughput is not incremental. Rather, it is pronounced and this large increase was surprising and unexpected. It is advantageous to be able to increase the throughput through an apparatus because it means more material can be processed through that apparatus.

The static pressure at the outlet of the secondary column in FIG. 2 is less than that at the bottom of the downcomer of FIG. 1. Without being bound by theory Applicant believes that this makes it easier to displace more volumetric throughput of foam through the columns than if there was only the usual primary column. Put another way, it is easier to push the foam out of the columns and into the body of liquid which is at a higher pressure than the foam if a secondary column with its higher outlet is present. The static pressure in the liquid that has to be overcome by the foam issuing from the column is simply less.

Further, Applicant believes that the upwardly facing conduit outlet also contributed to improved performance.

Further, advantages are conferred by the secondary column which discharges the foam into the body of water into the upper region of water. The distance from the upper region to the froth layer is short. Thus, there is less chance of it dropping off the foam or gas surface and into the body of liquid. Further, the waste particles can separate from the value particles attached to the foam in a zone that is effectively dedicated to separation. Thereafter the particles can displace by gravity through the central region unhindered by any other activity or interferences. Finally, the particles can settle in the lower region which is quiet and undisturbed because the outlet of the secondary column is remote therefrom.

If the bubbles did enter the lower zone they could get mixed up with the solid that have settled and this could hinder their rise through the liquid. As a result they might get carried out of the tank with the liquid. With this arrangement the bubbles are effectively kept away from the lower zone avoiding this situation.

It would be disadvantageous if the lower region which is effectively a temporary storage of settled particles was stirred up, e.g. by foam issuing from a column.

This would tend to mix up waste and value particles and detract from the efficiency of the machine.

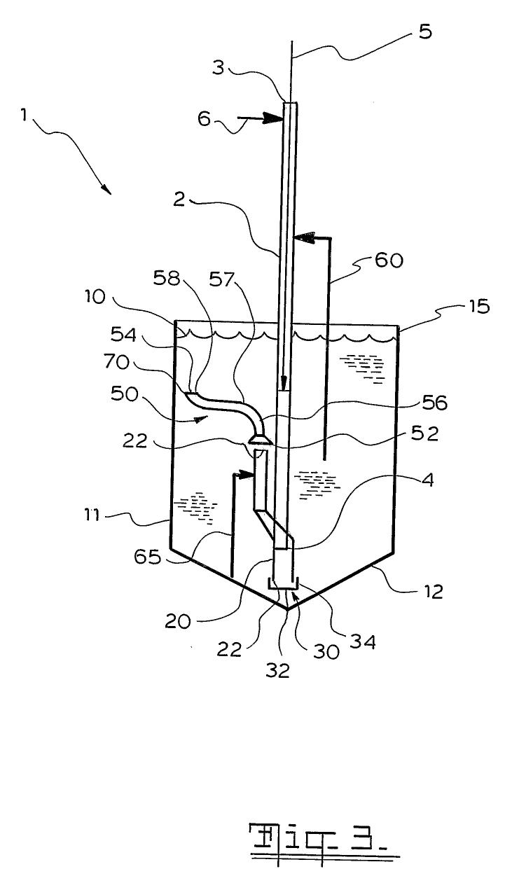

In FIG. 3 an apparatus in accordance with a second embodiment of the invention is shown.

This apparatus 1 has the same basic features as the apparatus 1 described above with reference to FIG. 2 and thus the same reference numerals will be used to refer to the same components unless otherwise illustrated.

The description below will focus on the features that are not contained in the FIG. 2 embodiment.

The apparatus 1 further includes a primary froth conduit in the form of a froth chimney 50 that extends from an upper end and outlet 24 of the secondary conduit 20 to a point spaced radially away from the inlet 22 and a short distance below the surface of the liquid. The froth chimney 50 has an inlet 52 proximate to the upper end and outlet 24 of the secondary column 20. The chimney 50 then extends generally radially outwardly and optionally also upwardly away from the primary column 21 to an upper end and outlet 54 that is positioned proximate to the radially outer edge of the tank 10.

The froth chimney 50 comprises the inlet 52, which is downwardly facing followed by an elbow 56 then a radial horizontally extending middle section 57 that is substantially horizontal and then a further elbow 58 and the outlet 54, which is upwardly facing. Further, the inlet 52 may be flared with a bell shape to direct water in through the inlet.

The purpose of the froth chimney 50 is to relocate the froth away from the area immediately around the primary column 2. This enhances froth movement and increases froth flow which in turn increases the vacuum draw through the columns 2 and 20 thereby and the flow rates through the columns.

The apparatus also includes a second damper 70 at the upper end 54 of the froth chimney 50. The damper 70 is in the form of a plate that can be slid over the upper end 54 of the upper end of the chimney 50 to vary the size of the opening defined thereby. This damper 70 enables an operator to control the velocity of the froth stream in the froth chimney 50 and also control the quality of the product that is produced.

Further, there are some structural differences between the secondary column in FIG. 3 and that shown in FIG. 2. In FIG. 3 a portion of the column 20 towards the lower end 22 thereof surrounds and encloses the lower end 4 of the primary column 2 as before. However, as it extends upwardly it is diverted away from the primary column 2 and does not circumferentially surround it as before. The upper 24 end is spaced well away from the primary column 2.

The apparatus 1 also includes a first recycle conduit 60 for recycling liquid and fine particulate material from an upper region 38 of the liquid in the tank 10 to the primary column 2 and a second recycle conduit 65 for recycling liquid and coarse particles from a lower region 36 of the liquid in the tank 10 to one of the primary or secondary conduits 2 or 20. In the illustrated embodiment the coarse particles are recycled to the secondary column 20.

In use water is introduced into the primary column 2 as a jet. This jet entrains air and rapidly forms a bed or column of foam that flows down the column 2 and issues from the lower end 4 thereof. This foam column is then drawn up through the secondary column 20 and issues through its upper end 24 and into the liquid as froth bubbles. Thereafter the froth bubbles and some liquid enter the inlet 52 to the froth chimney 50 which distributes the froth to a radially outer position within the tank 10 away from the primary column 2.

Water and fine mineral particles from an upper region of the tank 10 are drawn through the first recycle conduit 60 and sent back into the primary column 2 where they are exposed to high levels of aeration and gas phase surface area in the foam bed. This gives the mineral particles another opportunity to attach to the froth and be recovered in the froth stream.

Similarly the second recycle conduit 65 draws water and coarse particles from a lower region of the tank 10 and delivers them into the secondary column 20 from where they have another opportunity to attach to the froth. The pressure gradient in the columns 2 and 20 and the tank 10 means that water and particles are drawn through the recycle conduits 60 and 65 automatically and do not need to be pumped through it.

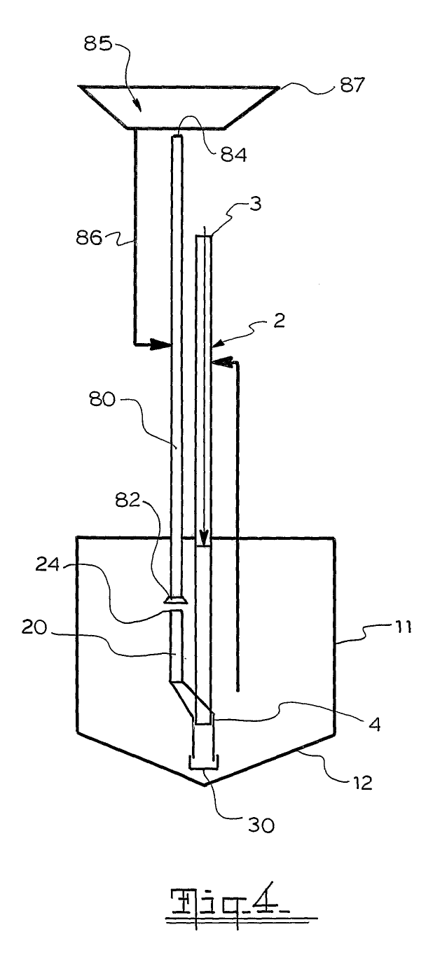

FIG. 4 shows an apparatus 1 in accordance with a third embodiment of the invention is shown.

This apparatus 1 has the same basic features as the apparatus described above with reference to FIG. 2 and thus, the same reference numerals will be used to refer to the same components unless otherwise illustrated.

The description below will focus on the features that are not contained in the FIG. 2 embodiment.

This embodiment has a secondary conduit 20 that is like that described above and illustrated in FIG. 3. It does not, however, have a chimney 50 as shown in FIG. 3.

In FIG. 4 the froth recovery means of the apparatus is a further tank or vessel that is separate from the tank 10 and placed in another location. The froth recovery means does not form part of the tank like that in FIG. 2.

The apparatus 1 further includes a froth transfer conduit 80 having an inlet and lower end 82 proximate to the upper end 24 of the secondary column 20 and an outlet 84 and a froth recovery vessel 85 into which the outlet 84 of the froth transfer conduit 80 leads. The lower end 82 of the froth transfer conduit 80 is aligned with the column 20 and spaced a short distance above the upper end 24 thereof. Further, the lower end 82 is flared to guide water in through the inlet it defines.

In the drawing the vessel 85 is positioned spaced above the tank 10 and away there from. However, it is to be appreciated that the drawing is schematic and it could be positioned in any position away from the tank 10. The advantage of positioning the vessel 85 as high as possible relative to the other components of the apparatus is that it gives the froth within the vessel 85 a high static head. This static head can be used to transfer the froth to the next stage of processing downstream of the flotation apparatus. Accordingly, a pump is not required to pump the froth to its next processing stage. This is advantageous because it is well recognised in the art that it is difficult to pump froth from one point to another.

The apparatus further includes a secondary froth recycle conduit 86 having a conduit inlet in the vessel 85 and extending to a conduit outlet in the froth transfer conduit 80. This recycles particle containing liquid from the vessel 85 back into a high aeration zone provided by the conduit 80.

The froth recovery vessel 85 is typically short and squat with a perimeter wall forming a weir 87 over which the froth layer is discharged. The vessel 85 contains liquid into which the outlet 84 of the conduit 80 discharges much like the tank 10 subject to the caveat that the concentration of waste particles in the vessel 85 will be lower. Conveniently the vessel 85 may be circular although it need not be this shape.

In use froth discharging from the outlet 24 of the secondary column 20 enters the liquid in the tank 10 and from there the froth bubbles and some liquid are drawn into the froth transfer conduit 80 and then transferred to the recovery vessel 85. The pressure profile through the columns means that the froth is drawn into the conduit 80 and vessel 85 and does not need to be pumped in to the vessel 85. Froth is then removed from the froth recovery vessel 85 by means of the overflow weir 87 like that described above.

By concentrating the froth together in a vessel 85 away from the tank 10 mineral losses from the froth into liquid within the tank 10 are contained. The mineral in the liquid in the vessel 85 that is not floated off can be recycled and recovered by introducing this liquid into one of the high aeration zones in the apparatus 1 such as the primary or secondary columns 2 or 20 or even the froth chimney 60 or froth transfer conduit 80. This feature has the potential to considerably enhance recovery of mineral in the flotation step.

In this embodiment the tank 10 does not hold the froth layer and can have a much smaller volumetric size as a result.

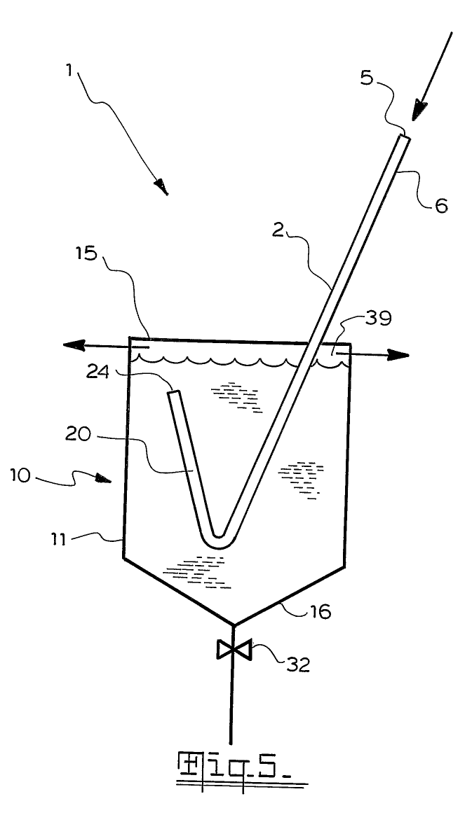

FIG. 5 illustrates a fluid jet flotation apparatus in accordance with another embodiment of the invention.

This apparatus 1 has the same basic features as the apparatus 1 described above with reference to FIG. 2 and thus the same reference numerals will be used to refer to the same components unless otherwise illustrated.

The description below will focus on the features that are not contained in the FIG. 2 embodiment.

As shown in the drawing the apparatus has a conduit with an inlet positioned above the tank. An initial leg of the conduit extends downward from the inlet to a low point submerged within the liquid in the tank. In fact, the conduit extends down to a point spaced above the bottom of the tank. After this low point the conduit changes direction and turns upward with a subsequent upward extending leg.

The upper end of the subsequent leg is open and defines an upwardly facing outlet that discharges the foam bed into the body of liquid within the tank at a point in the upper region of the tank but spaced beneath the layer of froth. In fact, the outlet may be positioned about 200-400 mm, e.g. about 300 mm beneath the froth layer.

This embodiment discharges the foam bed into the liquid in an upward direction in a region of the tank that is spaced away from the bottom of the tank. At the same time the foam is discharged into the liquid well below the froth layer. This allows the froth bubbles and attached value particles to rise through a quiescent zone of liquid and enter the froth layer with minimal detachment of value particles.

Further, the draw of the foam bed through the conduit is increased over prior art devices. This is because the pressure in the liquid is lower than if the outlet was positioned in the bottom of the tank. As a result less energy is required to displace the foam bed out into the body of liquid in the tank.

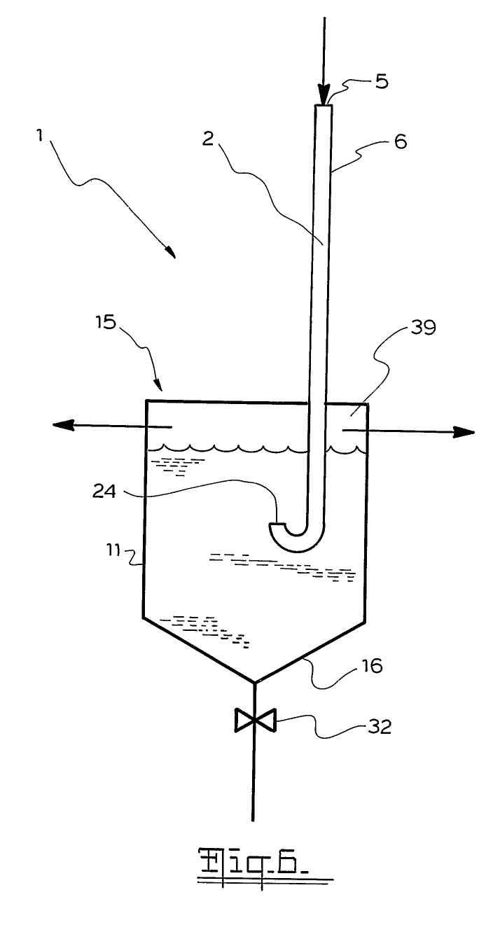

FIG. 6 illustrates a fluid jet flotation apparatus in accordance with another embodiment of the invention.

This apparatus 1 has the same basic features as the apparatus 1 described above with reference to FIG. 2 and thus, the same reference numerals will be used to refer to the same components unless otherwise illustrated.

The description below will focus on the features that are not contained in the FIG. 2 embodiment.

The apparatus has a conduit 2 that is positioned high above the tank. It extends linearly down from the inlet 3 to a lowest point within the body of liquid within the tank 10 but spaced well above the bottom of the tank 10. In fact, the lowest point could be said to be within the upper region of the tank 10.

At the lowest point the downward extending conduit 2 turns around and then extends up a short distance before terminating in an open end. The open end forms an outlet 24 that is positioned in an upper region of the tank 10 and is facing upward.

Again for the same reasons as the FIG. 5 embodiment, this apparatus enables an efficient separation of the froth with attached values from the unattached waste particles to take place. It also provides an increased draw through the conduit when compared with prior art apparatuses.

The Applicant has built a laboratory scale prototype of the apparatus shown in FIG. 2 and has carried out experiments with coal recovery to verify the efficacy of the invention.

Applicant has established that the invention is indeed efficacious in increasing the throughput through the primary column. Applicant has produced a number of graphs showing the results of its experimental work.

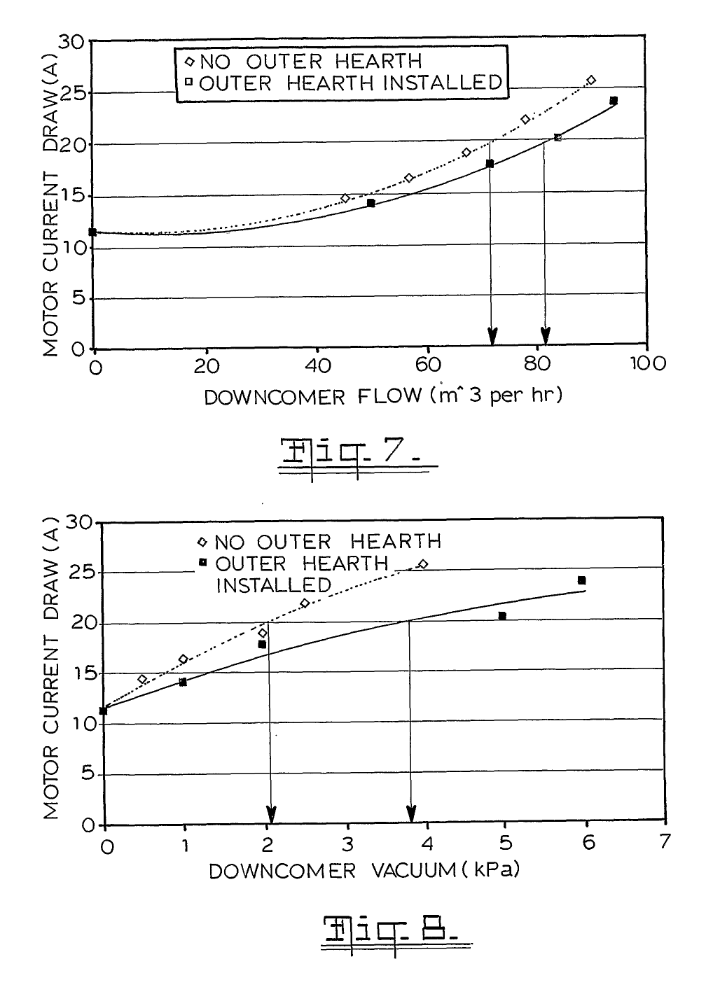

FIG. 7 is a graph that plots recovery of value particles which is coal as a function of tank residence time for a number of flotation apparatuses including the apparatus shown in FIG. 2. This graph clearly shows an increased recovery of value particles for a given residence time over a Jameson Cell. The improvement in recovery over that achieved in the currently known and used Jameson Cell is significant and not merely incremental. Further, the graph also plots the results achieved for the same experiment with a mechanical flotation cell.

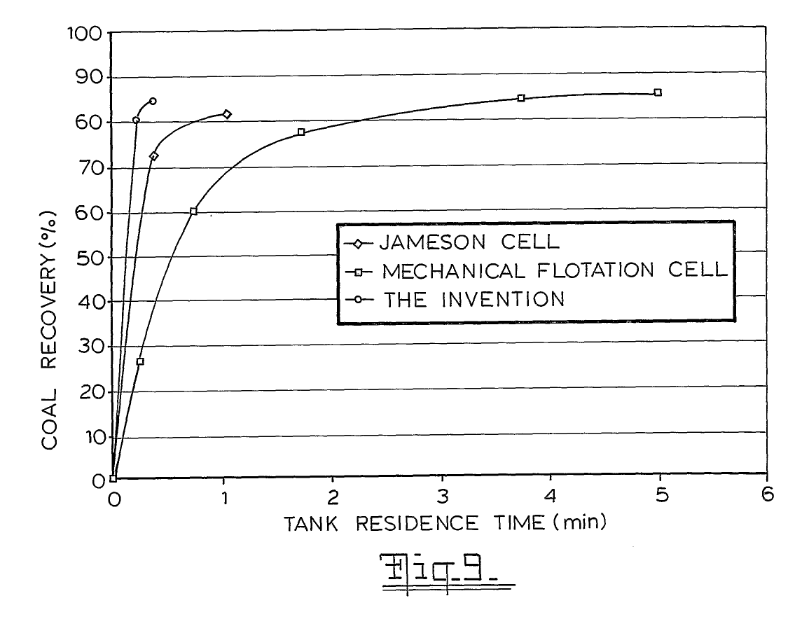

FIG. 8 is a graph that plots the recovery of value particles as a function of normalised downcomer flow for the same apparatuses. This graph would give an indication of the volumetric throughput that could be processed through each apparatus.

As with FIG. 7 the results point to the apparatus in FIG. 2 having a clearly superior performance to the Jameson Cell. They clearly show a substantially increased downcomer flow when using the apparatus illustrated in FIG. 2.

This provides evidence of the fact that the invention enables the through put through the apparatus to be increased.

Applicant believes that this is due to the more efficient discharge of the foam bed from the outlet of the secondary column into the body of the liquid. The outlet of the secondary column is facing up and is also positioned substantially higher up in the tank of liquid. As a result the pressure in the secondary column and also the primary column is lower than would be the case for the FIG. 1 prior art apparatus. If the pressure in the primary and secondary columns is lower this will draw more foam through the columns and the throughput will increase and this is the effect that has been observed by the Applicant.

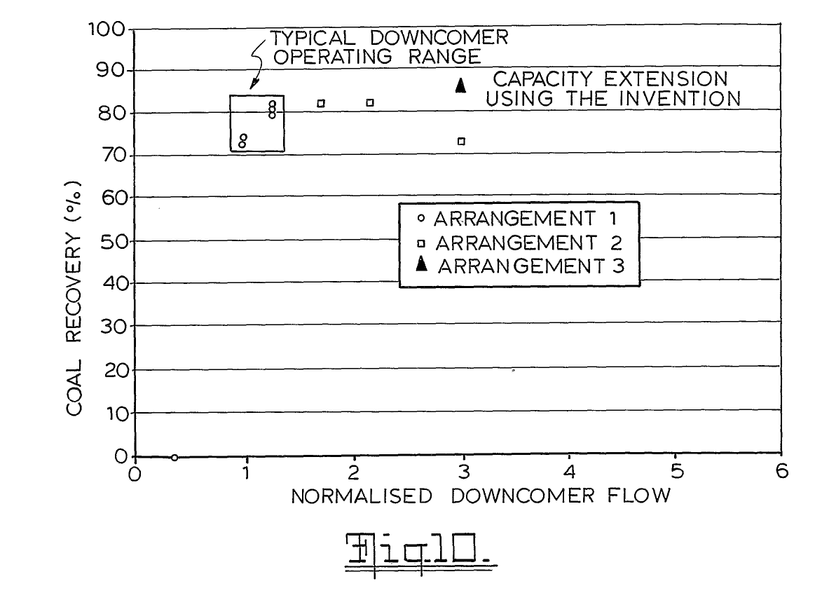

FIG. 9 is a graph showing current draw for the pump used for pumping water in through the inlet as a function of the volumetric flow rate through the downcomer or primary column. The graph compares a Jameson Cell as shown in FIG. 1 with a FIG. 2 apparatus in accordance with the invention.

For an equivalent downcomer flow the FIG. 2 apparatus forming this invention draws measurably less current. This is indicative of the fact that the pressure in the downcomer of FIG. 2 is less than that in the downcomer of FIG. 1.

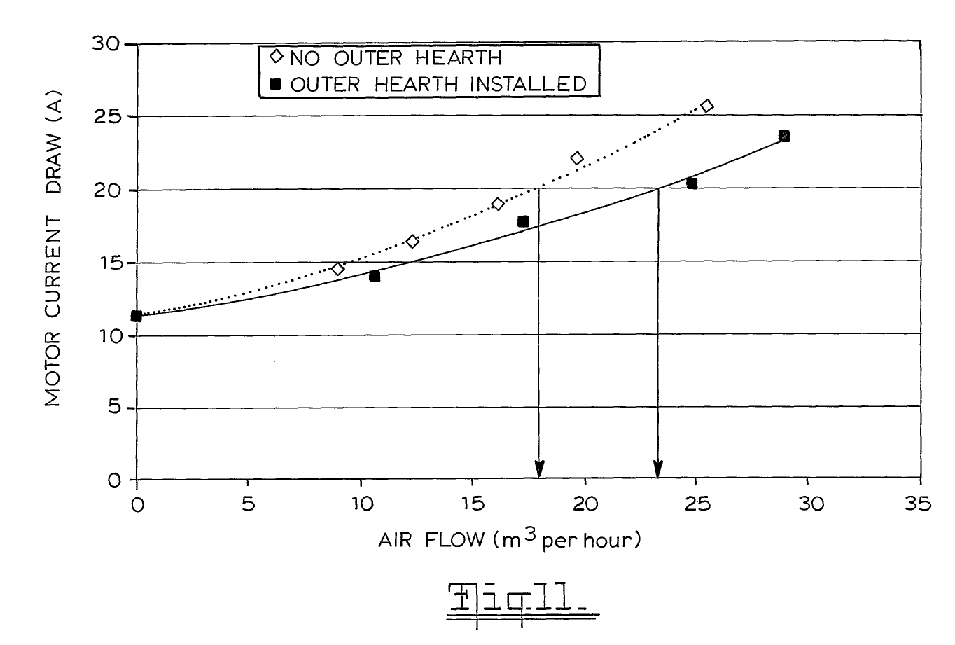

FIG. 10 is a graph showing the current draw for the pump as a function of the vacuum or pressure in the downcomer. For a given current draw the FIG. 2 apparatus applies a clearly stronger vacuum and this supports the Applicant's contention that there is a lower pressure and a stronger draw in the downcomer of the FIG. 2 apparatus. The stronger vacuum explains the greater downcomer flow shown by FIG. 9 as the draw in the downcomer is greater.

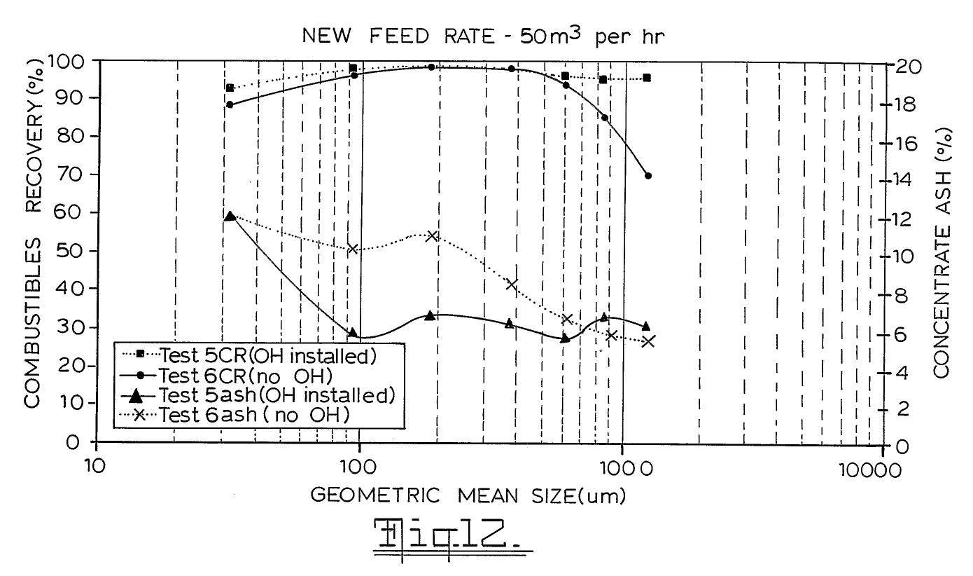

FIG. 11 is a graph that plots current draw as a function of air flow through the air inlet into the downcomer.

Again, this graph clearly shows a greater flow of air for a given current draw in the FIG. 2 apparatus. This occurs because the draw in the primary column is greater. This is really the same as saying the vacuum is stronger in the FIG. 2 apparatus as shown in FIG. 10. This experiment confirms and corroborates the results demonstrated in FIG. 10.

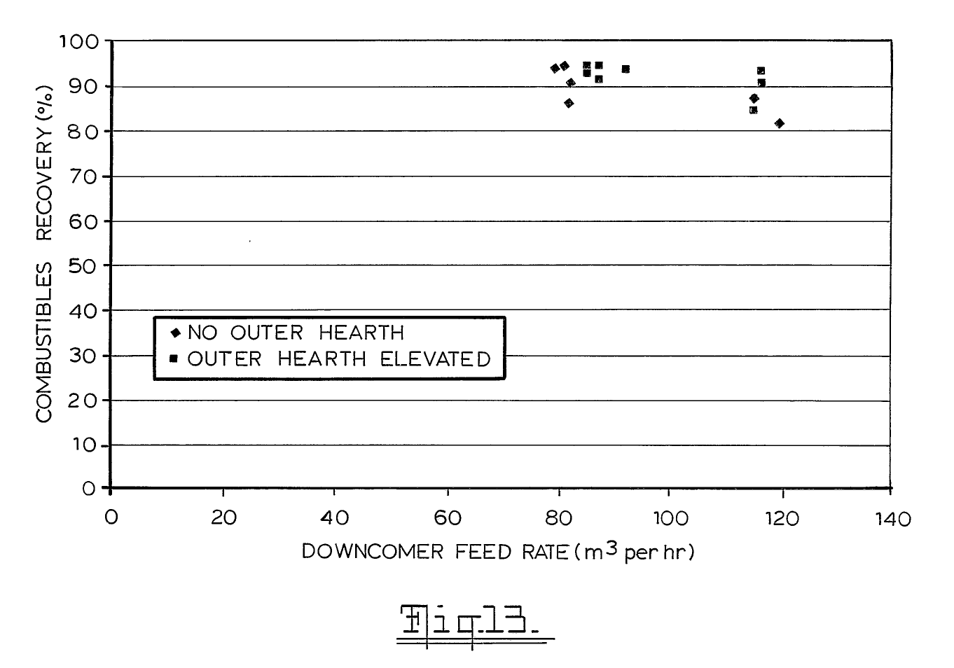

FIG. 12 is a graph that plots values recovery in the form of combustibles in a coal float as a function of geometric mean size and also ash in the concentrate as a function of geometric mean size.

This graph shows a better recovery of values in the FIG. 2 apparatus than the FIG. 1 apparatus particularly at smaller mean particle sizes and larger mean particle sizes. For particle sizes in the middle the results are similar for the FIG. 1 and FIG. 2 apparatus.

The graph also shows on balance less recovery of ash in the concentrate for the FIG. 2 apparatus than obtained in the FIG. 1 apparatus. This indicates superior performance in the FIG. 2 apparatus. This effect is substantial and pronounced over the majority of the particle sizes. However, it is not shown for the large particle sizes where the trend is reversed.

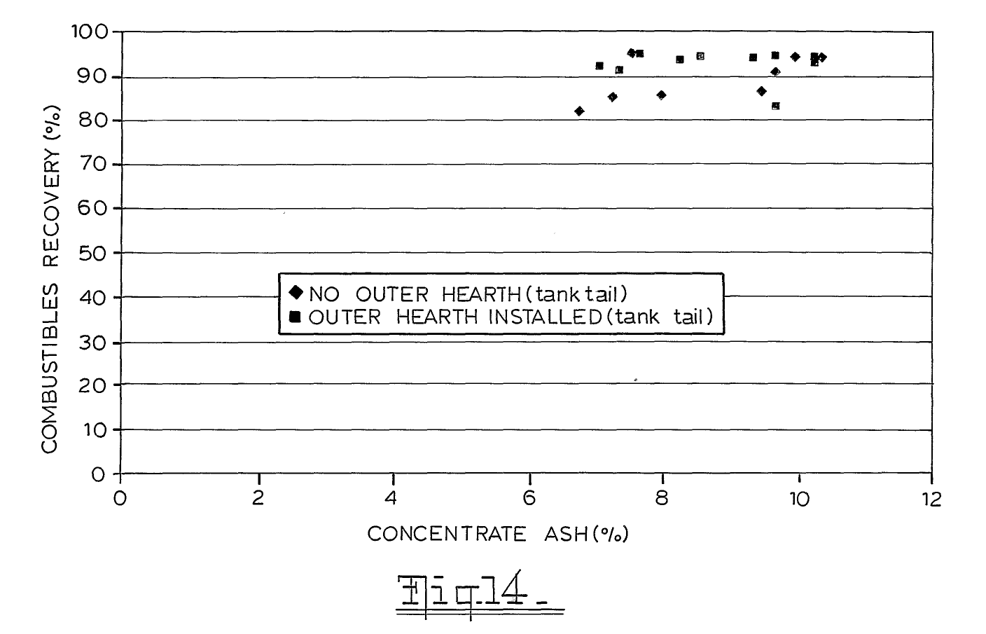

FIG. 13 plots combustibles recovery as a function of downcomer or conduit feed rate.

This clearly shows a greater downcomer feed rate for the FIG. 2 apparatus over the FIG. 1 apparatus at a comparable level of combustibles recovery. That is the flow rate through the conduit is greater for an approximately equivalent performance.

Further, for a similar flow rate through the conduit the recovery of values in the FIG. 2 apparatus is better than in a FIG. 1 apparatus.

This clearly shows the superior performance of the FIG. 2 apparatus over the FIG. 1 apparatus.

FIG. 14 plots values recovery in the form of combustibles of coal as a function of waste particles in the form of ash in the concentrate stream. This graph clearly shows that for a given ash percentage in the concentrate the values recovery is greater for the FIG. 2 apparatus than the FIG. 1 apparatus.

For a given combustibles recovery the result is not as clear cut. However, on balance the percentage of ash in the concentrate is slightly less for the FIG. 2 apparatus than the Fig apparatus.

An advantage of the apparatus described above and illustrated in FIGS. 2 to 6 is that it improves the recovery of value particles in the apparatus. Specifically, it improves the separation of value particles from waste particles in the body of liquid in the tank. It does this by providing a quiescent zone in the tank spaced away from the bottom where the settled waste particles are resting. Further, less pressure energy is required to discharge the foam bed from the column into the liquid and as a result, the discharge is less aggressive and less turbulent. It also improves the ability of value particles attached to the froth to rise up through the liquid and enter the froth layer without getting detached from the froth and bubbles. It does this by the flow dynamics and non turbulent flow. It also does this by having an upwardly opening outlet that permits the froth bubbles to rise straight up without having to deviate around the conduit. It is also assisted by the shorter distance from the outlet into the froth layer.

It also reduces the chance of settled waste particles in the liquid being drawn into the froth layer by spacing the lower region of the tank generally away from the point where the foam bed issues from the conduit and away from the region where the froth bubbles rise and the waste particles settle out.

Further the apparatus increases the draw through the conduit and particularly the draw through both the primary and secondary conduits. It does this by the reduction in the pressure in the liquid at the point where the foam bed issues from the conduit. Thus, the back pressure in the tank is less and the pressure driving force across the conduit is greater and this increases the driving force for flow of the foam bed and the volumetric flow through the conduit.

A further advantage of the apparatus in FIG. 3 is that it is able to use a froth conduit utilising the natural draw in the conduits to transfer froth away from the conduit.

A further advantage of the apparatus in FIGS. 3 and 4 is that it is able to recycle liquid and particles from the body of liquid back into a said conduit, e.g. a column where it is exposed to a high aeration zone. The pressure in the body of liquid in the conduit is lower than that in the tank due to the jet in the conduit and this pressure difference is used to recycle the liquid and mineral through the high aeration zones. This enables mineral particles that were not recovered in the first pass to be subsequently recovered. A particularly elegant feature of this invention is that these advantages are achieved passively by utilising pressure energy that is already in the system and not external pumping energy.

Further the increases in throughput that have been achieved by the Applicant utilising the arrangements described above are substantial rather than incremental. Applicant has achieved increases in throughput of greater than 100% with some configurations.

Finally, an advantage of the apparatus in FIG. 4 is that it recovers the froth in vessel separately from the first tank. As a result, the first tank can have a much smaller volume. Further, the froth recovery vessel can be positioned above the first tank. This therefore confers a greater number of design options.

It will of course be realised that the above has been given only by way of illustrative example of the invention and that all such modifications and variations thereto as would be apparent to persons skilled in the art are deemed to fall within the broad scope and ambit of the invention as is herein set forth.

The claims defining the invention are as follows:

1. A fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
a froth recovery means for recovering a particle laden froth from a froth layer that is formed by froth rising up through the liquid in the tank;
wherein the outlet of the conduit is spaced above a bottom of the tank.

2. A fluid jet flotation apparatus according to claim 1, wherein the outlet of the conduit is positioned in the relatively upper region of the tank such that foam issuing from the outlet passes into the liquid in said relatively upper region of the tank.

3. A fluid jet flotation apparatus according to claim 1, wherein the conduit outlet is positioned at least half way up the height of the tank and the outlet of the conduit in addition faces upwardly.

4. A fluid jet flotation apparatus according to claim 1, wherein the conduit comprises a first downwardly extending primary column extending down from the inlet and a secondary column extending upwardly up to the outlet in a direction broadly opposed to the direction of the downwardly extending primary column.

5. A fluid jet flotation apparatus according to claim 4, wherein the primary column has a lower end that is open and the secondary column longitudinally straddles the lower end of the primary column and the secondary column has a lower end that is substantially closed and proximate to the lower end of the primary column and an upper end that opens into the tank above the lower end of the primary column.

6. A fluid jet flotation apparatus according to claim 4, wherein the secondary column longitudinally straddles the lower end of the primary column by being spaced below the lower end of the primary column and circumferentially surrounding the lower end of the primary column and the upper end of the secondary column is spaced far above the lower end of the primary column.

7. A fluid jet flotation apparatus according to claim 4, wherein the height of the secondary column may be at least one quarter of the distance from the lower end of the primary column to the level of the weir on the tank.

8. A fluid jet flotation apparatus according to claim 4, wherein the secondary column circumferentially surrounds the primary column along the full length of the secondary column from its lower end to its upper end defining an annular space outside of the primary reactor.

9. A fluid jet flotation apparatus according to claim 4, wherein the secondary column, towards its lower end, circumferentially surrounds the lower end of the primary column and then the secondary column is directed or angled away from the primary column, such that the upper end thereof does not surround the column.

10. A fluid jet flotation apparatus according to claim 4, wherein the apparatus further includes means for adjusting the pressure in the conduit in the form of a damper that is mounted over the lower end of the secondary column, whereby to adjust the flow rate of foam in the secondary column.

11. A fluid jet flotation apparatus according to claim 10, wherein the tank has a peripheral wall with an upper edge defining a top that opens to the atmosphere and wherein the froth recovery means comprises an overflow weir formed by said upper edge of the tank over which the froth layer can be discharged from the tank.

12. A fluid jet flotation apparatus according to claim 1, wherein the conduit includes a nozzle that defines the inlet there to and the nozzle causes liquid to enter the column as a jet of liquid and wherein the apparatus further includes a supply of gas that can be drawn into the conduit through the gas inlet by negative pressure generated by the jet.

13. A fluid jet flotation apparatus according to claim 1, wherein the apparatus further includes a recycle conduit extending from an inlet positioned within the body of liquid within the tank to an outlet that is positioned in the conduit which has high levels of aeration.

14. A fluid jet flotation apparatus according to claim 13, wherein a said recycle conduit extends from an upper region of the body of liquid in the tank to a point on the primary column above the tank and below the gas inlet.

15. A fluid jet flotation apparatus according to claim 14, wherein a further recycle conduit extends from a point near the bottom of the tank up to a point on the secondary column spaced above it.

16. A fluid jet flotation apparatus according to claim 1, further including a froth conduit having an inlet positioned in proximity to the outlet of the conduit and an outlet spaced away from the outlet of the conduit.

17. A fluid jet flotation apparatus according to claim 16, wherein the froth chimney further includes a further damper mounted over the upwardly facing outlet of the froth conduit in the form of a plate that can be slid across the outlet of the froth chimney.

18. A fluid jet flotation apparatus according to claim 1, wherein the froth recovery means comprises a froth recovery vessel that is separate from the tank and spaced away from the tank and a froth transfer conduit having an inlet in operative association with the outlet of the conduit, or the froth chimney if there is one, and the froth transfer conduit has an outlet that discharges the froth into a body of liquid in the froth recovery vessel from where the value particles can be recovered in a froth layer by means of an overflow weir.

19. A fluid jet flotation apparatus according to claim 18, wherein the froth recovery vessel is positioned higher than the tank such that the froth has a high static head that can be used to displace the froth to a next stage of downstream processing and thereby obviate the need to pump the froth to the next stage.

20. A fluid jet flotation apparatus according to claim 18, wherein the froth recovery vessel includes a secondary froth recycle conduit for recycling liquid containing value particles from the froth recovery vessel that extends from the froth recovery vessel back into a said conduit.

21. A fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
a froth recovery means for recovering a particle laden froth from a froth layer that is formed by froth rising up through the liquid in the tank;
wherein the conduit is oriented such that the outlet of the conduit faces in an upward direction.

22. A fluid jet flotation apparatus according to claim 21, wherein the conduit is positioned such that the outlet of the conduit is spaced above the bottom of the tank, in addition to having the outlet facing upward.

23. A fluid jet flotation apparatus according to claim 21, wherein the conduit which initially is directed downward may then turn through at least 160 degrees and have an open end defining the outlet whereby to provide an outlet that faces substantially upwardly.

24. A fluid jet flotation apparatus according to claim 21, wherein the conduit comprises a downwardly directed primary column and a secondary column that circumferentially surrounds the primary column and then extends up there from to an upwardly opening upper end forming the outlet of the conduit.

25. A fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
a further conduit that is a froth conduit positioned above the outlet of the conduit and in proximity thereto and extending away from the outlet of the conduit to an outlet that is remote from the inlet, the froth issuing from the conduit into a body of liquid from where it rises to form a froth layer; and
a froth recovery means for recovering the particle laden froth from a froth layer that is formed by froth rising up through the liquid in the tank.

26. A fluid jet flotation apparatus according to claim 25, wherein the outlet of the conduit containing the foam bed faces in an upward direction and the inlet to the froth conduit is positioned above the outlet of the conduit in proximity thereto.

27. A fluid jet flotation apparatus according to claim 26, wherein the froth conduit has an inlet that faces downwardly and an outlet that faces upwardly.

28. A fluid jet flotation apparatus according to claim 27, wherein the inlet of the froth conduit is flared with a bell shape and the froth conduit extends radially and/or upwardly away from the outlet of the conduit and the froth conduit includes a further damper located proximate to the upper end of the froth chimney.

29. A fluid jet flotation apparatus, comprising:
a tank containing a liquid having a relatively lower region and a relatively upper region;
a conduit having a liquid inlet through which a particle-containing liquid is introduced to the conduit as a jet, a gas inlet through which gas is drawn into the column by the jet, the liquid and the gas forming a foam bed that is displaced through the conduit and out through an outlet remote from the inlet, the outlet being positioned so as to be received within the tank such that the foam discharging through the outlet passes into the liquid within the tank;
at least one recycle conduit extending from a point inside the tank to a point on the conduit such that liquid within the body of water in the tank can be recycled into the conduit where it is further brought into contact with the foam bed, the pressure within the body of liquid in the tank being greater than that in the conduit and this provides the driving force or pressure gradient for the liquid to be returned to the conduit; and
a froth recovery means for recovering the particle laden froth from a froth layer that is formed by froth rising up through the liquid in the tank.

30. A fluid jet flotation apparatus according to claim 29, wherein the conduit comprises a primary column having a vertically extending orientation and a secondary column straddling the lower end of the primary column having a lower end beneath the lower end of the primary column and extending upwardly to an upper end spaced above the lower end of the primary column.

31. A fluid jet flotation apparatus according to claim 30, wherein one recycle conduit recycles liquid and particles from the tank back into the primary column and another recycle conduit recycles liquid and particles from the tank back into the secondary column.

32. A fluid jet flotation apparatus, comprising:
a tank containing a liquid having a relatively lower region and a relatively upper region;
a conduit having a liquid inlet through which a particle-containing liquid is introduced to the conduit as a jet, an air inlet spaced from the liquid inlet through which air is drawn into the column by the jet, the liquid and the air forming a foam bed that is displaced through the conduit and out through an outlet remote from the inlet, the outlet being positioned within the tank such that the foam discharging through the outlet passes into the liquid within the tank;
a froth transfer conduit having an inlet positioned in proximity to the outlet of the conduit and extending away therefrom to an outlet positioned outside the tank; and
a froth recovery tank containing liquid outside of said one tank, the outlet of the froth transfer conduit discharging into the liquid in the froth recovery tank and the froth recovery tank defining an overflow weir for enabling the froth to overflow and be separated from the liquid in the froth recovery tank.

33. A fluid jet flotation apparatus according to claim 32, wherein the outlet of the conduit faces upwardly and the inlet of the froth transfer conduit faces downwardly and is positioned above the outlet of the conduit in close proximity thereto.

34. A fluid jet flotation apparatus according to claim 32, wherein the froth transfer conduit extends in an upward direction and the froth recovery tank is spaced above the one tank.

35. A fluid jet flotation apparatus according to claim 32, wherein the froth recovery vessel includes means for recycling liquid and associated particles from the recovery vessel in the form of a secondary froth recycle conduit that extends from the froth recovery vessel to the conduit carrying the foam bed or the froth transfer conduit.

36. A fluid jet flotation apparatus, comprising:
a primary column with a vertically extending orientation having an inlet through which particle-containing liquid is directed downwardly into the column associated with an upper end and a lower end which is open and also a gas inlet spaced in from the upper end;
means for introducing the liquid through the inlet under pressure so that the liquid is directed down the column;
a tank within which the primary column is received which contains liquid in use;
a froth recovery means for recovering particle-containing froth to be recovered in a froth layer separately from the liquid;
a secondary column longitudinally straddling the lower end of the primary column and circumferentially surrounding the lower end of the column, the secondary column having a lower end proximate to the lower end of the primary column and then extending upwardly to an upper end spaced above the lower end of the primary column;
at least one recycle conduit extending from a point inside the tank to a point on the conduit such that liquid within the body of water in the tank can be recycled into the conduit where it is further brought into contact with the foam bed, the pressure within the body of liquid in the tank being greater than that in the conduit and this provides the driving force, or pressure gradient, for the liquid to be returned to the conduit; and
a froth conduit positioned above the upper end of the secondary column and extending generally away from the primary column for directing froth away from the primary column;
whereby liquid to be treated is introduced into the primary column through the liquid inlet and this generates a pressure gradient in the columns and conduit that draws gas through the gas inlet generating a column of froth that moves down the primary column, through the secondary column, through the froth conduit and then into the froth recovery means from where it is recovered.

37. A fluid jet flotation apparatus according to claim 36, wherein the wherein the tank has a peripheral wall with an upper edge defining a top that opens to the atmosphere and wherein the froth recovery means comprises an overflow weir formed by said upper edge of the tank over which the froth layer can be discharged from the tank.
